(19) United States
(12) Patent Application Publication
(10) Pub. No.: US 2020/0061760 A1
(43) Pub. Date: Feb. 27, 2020

(54) INDUCTION COIL UNIT FOR A SHRINK DEVICE AND WITH CHUCK DETECTION AND AUTOMATIC COIL ADJUSTMENT

(71) Applicant: HAIMER GMBH, Genhausen (DE)

(72) Inventor: ANDREAS HAIMER, IGENHAUSEN (DE)

(21) Appl. No.: 16/532,540

(22) Filed: Aug. 6, 2019

(30) Foreign Application Priority Data
Aug. 24, 2018 (DE) 20 2018 104 875.9

(51) Int. Cl. B23P 11/02; H05B 6/14; H05B 6/38

(52) U.S. Cl. CPC B23P 11/027; H05B 6/38; H05B 6/14

(57) ABSTRACT

An induction coil unit for heating a sleeve portion of a tool holder which has a receiving opening for a shank of a rotary tool, the sleeve portion holds the shank of the tool seated in the opening in a press fit and releases it upon heating. The induction coil unit has a holding apparatus for holding the tool holder, a coil arrangement that encloses the sleeve portion during a heating operation, and a magnetic flux concentrator arrangement that is arranged near the free end of the sleeve portion. A detector for detecting a property of the tool holder held by the holding apparatus is provided. An actuator for adapting an operating parameter of the heating operation is further provided along with a controller that communicates with the detector to obtain data relating to the tool holder, and with the actuator to direct the adaptation of the operating parameter.

### CROSS-REFERENCE TO RELATED APPLICATION

This application claims the priority, under 35 U.S.C. § 119, of German application DE 20 2018 104 875.9, filed Aug. 24, 2018; the prior application is herewith incorporated by reference in its entirety.

### BACKGROUND OF THE INVENTION

### Field of the Invention

The present invention relates to an induction coil unit for heating a freely-terminating sleeve portion of a tool holder that contains a receiving opening for a shank of a rotary tool, in which this sleeve portion holds the shank of the tool seated in the receiving opening in a press fit and releases it upon heating. The induction coil unit has a holding apparatus that holds the tool holder during a heating operation, a coil arrangement that encloses the sleeve portion during a heating operation, and on the side of the coil arrangement adjacent to the free end of the sleeve portion, a magnetic flux concentrator arrangement that may be arranged at least near the free end of the sleeve portion of the tool holder and is made of a weakly-magnetic material that is substantially electrically non-conductive.

Generic induction coil units of this kind are known in the art, for example from published, European patent application EP 1 867 211 A1, corresponding to U.S. Pat. No. 9,278,414, and are used to thermally expand tool holders by means of alternating magnetic fields and the eddy currents that are induced in the tool holders as a result, so that the tool maybe used in this expanded state. After the tool holder has undergone a cooling process, the tool holder holds the tool firmly and symmetrically. For a more detailed description of the technical and operational background, please refer to the above-mentioned patent application.

In generic units of this kind, however, the problem arises that, for efficient operation, the various operating parameters of the induction coil unit must be individually adjusted to the tool holder held therein, which requires a high degree of manual intervention and may therefore, under certain circumstances, significantly increase the cycle times for changing a tool in different types of tool holders. On the other hand, if the coil unit is not adjusted for the currently-held tool holder or is adjusted incorrectly, under certain circumstances the coil unit may operate inefficiently, because the intended eddy currents will not be not suitably induced in the tool holder. In particularly unfavorable cases, the tool holder may even overheat and be destroyed.

### SUMMARY OF THE INVENTION

The object of the present invention, accordingly, is to refine a generic induction coil unit in such a way as to eliminate the above-mentioned drawbacks of the units of this kind that are known from the prior art, in particular so that the induction coil unit according to the invention may have an increased degree of automation and accordingly may have high operational reliability even at shorter cycle times.

To this end, the induction coil unit according to the invention contains at least one detection device for automatically detecting at least one property of the tool holder that the holding apparatus holds; at least one actuator device for adapting at least one operating parameter of the heating operation; and a control unit that is in data communication, respectively, with the at least one detection device to obtain data relating to the tool holder and with the at least one actuator device to direct the adaptation of the at least one operating parameter. The control unit is adapted to direct the adaptation of the at least one operating parameter based on recognition of at least one property of the tool holder, respectively.

As a result of thus automatically adapting the unit's operation according to the invention based on the at least one detected property of the tool holder, manual intervention to adjust that operation is no longer required; thus, the time previously required for such interventions may be saved, while still maintaining high standards of operational safety and tolerances by automatically adapting the unit to ensure that it is operating correctly.

Various operating parameters of the induction coil unit according to the invention that the actuator device is able to adjust may be used. For example, a positioning of the coil arrangement in a heating operation may be adjusted, particularly along the axial direction of the tool holder. This relatively simple embodiment is based on the consideration that the coil arrangement, in its released state, is axially guided away from the tool holder that the unit holds, in order to enable accessing and replacing the tool holder.

The coil arrangement is not energized so as to heat the tool holder until it has been switched into a working operation in which it surrounds the tool holder radially. The actuator device according to the invention may control or regulate this switching of the coil arrangement so that after at least one property of the tool holder has been detected, the coil arrangement may be switched into its working state in an optimal position that is tuned to this tool holder. In this case, the at least one property of the tool holder may relate for example to the axial dimensions thereof. But geometric and/or magnetic properties of the coil arrangement may also be adapted.

For this purpose, the actuator device may in particular contain a movable stop means for the coil arrangement. In this way, the above-described usual displacement of the coil arrangement in the axial direction takes place in the usual way, and ultimately terminates at a suitable axial position as a result of striking the stop means.

Of course, in this case the displacement means of the coil arrangement must be furnished in such a way that the stop cannot damage the coil arrangement or other components of the unit according to the invention.

Alternatively or in addition, the actuator device may be adapted to adjust the positioning of the magnetic flux concentrator arrangement in the axial and/or radial direction of the tool holder during the heating operation. In this way, depending, for example, on the geometric dimensions of the tool holder, the magnetic flux concentrator arrangement may be optimally arranged with respect to the outer circumference of the tool holder, based on the recorded at least one property, which in this case may correspondingly relate to, for example, the outer dimensions of the tool holder.

Furthermore, the unit according to the invention may comprise at least one suction device for vapor produced during heating and/or a sealing element for cooling media, and the actuator device may be adapted to adjust the positioning of the at least one suction device and/or the at least one sealing means for cooling media in the tool holder's axial and/or radial direction during the heating operation. In this context as well, the at least one property of the tool holder that the detection device detects may correspondingly relate to the outer dimensions thereof.

In the event that the coil arrangement is furnished with an adjustable geometry and/or switchable and/or reversible-polarity winding regions, the actuator device may additionally be adapted to adjust the geometry of the coil arrangement, in particular the diameter and/or axial distance between the various winding regions thereof and/or to switch winding regions of the coil arrangement on or off and/or to reverse the polarity of these winding regions. Obviously, particularly in the case of switchable and/or reverse-polarity winding regions, the actuator device is not a mechanical actuator in the strict sense, but rather actuates elements of the electrical supply unit for the coil arrangement, for example electronic control switches or the like.

Finally, the actuator of the unit according to the invention may also be adapted to adjust parameters of the coil arrangement's electrical supply, in particular the applied AC voltage and/or the frequency thereof and/or the duration thereof. In this way it may be taken into account, for example, that the wall thickness of various types of tool holders may be different for the same external dimensions and therefore induced eddy currents of different strengths may be necessary to achieve the necessary expansion of these tool holders. In this embodiment as well, the actuator device is not a mechanical actuator in the strict sense, but, for example, an electronic circuit that may influence the power supply unit of the induction coil.

As indicated above, the detection device may be adapted to detect various properties of the tool holder that the holding apparatus holds, for example the outer dimensions, wall thickness, or axial extension thereof.

To this end, the detection device may be adapted to optically determine the at least one property of the tool holder held by the holding apparatus based on its shape, its weight, its magnetic properties, haptic sensing and/or ultrasonic imaging. Obviously, to achieve this, the detection device must be equipped with suitable sensors and, if necessary, with suitable transmitters, for example optical cameras with downstream image analysis, weight sensors, induction sensors for recording magnetic properties, touch sensors and/or an ultrasound source and compatible ultrasound receiver.

Alternatively, however, the detection device may also be intended to detect one or more codings furnished on the tool holder, in particular an optical coding, an inscription, an RFID chip and/or a mechanical marking.

The detection of such a marking is particularly advantageous if it is possible to determine directly from this the type of tool holder currently being held, the properties of which must then be known by the control unit. To this end, the control unit may be associated with a memory unit in which corresponding data may be stored that enable the control unit to determine the type of tool holder held by the holding apparatus, based on the information obtained from the detection device, and on that basis to transmit corresponding instructions to the actuator device.

Thus, according to the invention, it is possible either to determine the relevant properties of the tool holder directly via the detection device and transmit them to the control device; or to have the control device determine the type of tool holder held based on the at least one property that the detection device detects; and then, based on this data, respectively direct the actuator device either to adapt parametrically or to perform an adaptation matched to the detected type of tool holder.

Of course, all the above-mentioned possibilities may be implemented individually or in any combination, respectively.

The invention and its advantageous embodiments and/or refinements, as well as the advantages thereof, are explained in greater detail below, purely by way of example, with reference to drawings.

Other features which are considered as characteristic for the invention are set forth in the appended claims.

Although the invention is illustrated and described herein as embodied in a shrink device with chuck detection and an automatic coil adjustment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an exemplary embodiment of a shrink device according to the invention, for shrinkable tool holders for rotating tools;

FIG. 2 is an axial longitudinal sectional view through an induction coil unit with adjustable yoke arrangement, which may be used in the shrink device of FIG. 1;

FIG. 3 is a detailed sectional view through the induction coil unit from FIG. 2;

FIG. 4 is a top view of the induction coil unit of FIG. 2;

FIG. 5 is a perspective view of yoke elements of the induction coil unit from FIG. 2; and

FIG. 6 is an axial longitudinal sectional view through one exemplary embodiment of a tool holder for a rotating tool that may be used in connection with the shrink device of FIG. 1.

### DETAILED DESCRIPTION OF THE INVENTION

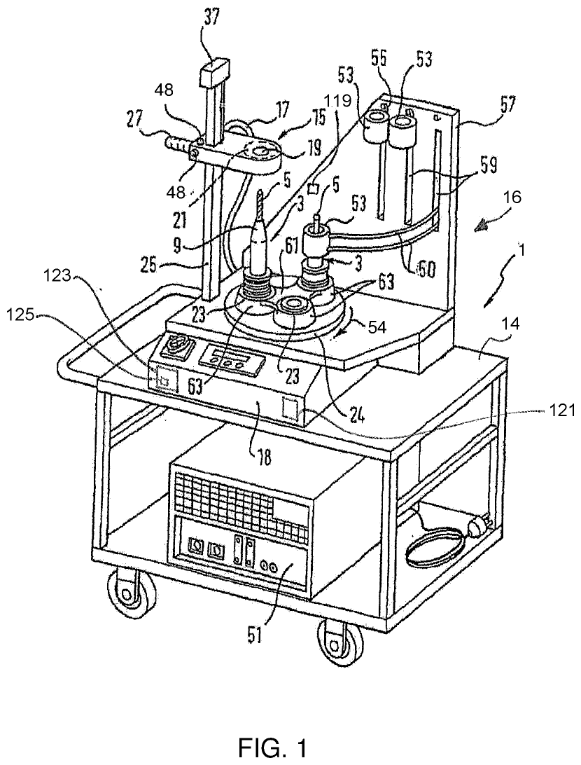

Referring now to the figures of the drawings in detail and first, particularly to FIG. 1 thereof, there is shown a shrink device 1 that may be transported as a single unit, for tool holders of rotating tools 5 such as for example drill bits or milling cutters. Such tool holders have, as for example FIG. 6 shows, a connecting shank 7, for example in the form of a steep cone or a hollow partial cone or the like, and by means of this shank, they may be centrally clamped into a machine tool, as well as a sleeve-shaped tool receiving region 9, axially opposite the connecting shank 7, with a central, substantially cylindrical receiving opening 11 for the shank 13 of the tool 5. In a clamping region 12 of the tool holder 3, the inner diameter of the receiving opening 11 is slightly smaller than the outer diameter of the shank 13; consequently, the receiving region 9 of the tool holder 3 must be heated before the shank 13 of the tool 5 may be inserted into the clamping region 12 of the receiving opening 11, due to thermal expansion. After the receiving region 9 has cooled, the shank 13 is then in a press fit in the tool holder.

The shrink device 1 (FIG. 1) is able to sufficiently heat the receiving region 9 of the tool holder 3 within a few seconds (for example 10 seconds), for example heating the receiving region 9 of the tool holder 3 to temperatures of 300° C., and subsequently to cool it in turn to ambient temperature in a comparably short time (for example 30 seconds). In this case, an induction coil unit 16 is fastened onto a transport carriage 14 of the shrink device 1.

To heat the receiving region 9, the shrink device 1 has an induction coil unit 15 that is fed from an induction current generator 18 via a flexible cable 17. The induction current generator 18, in the exemplary embodiment shown here, generates alternating currents or pulsed direct currents with a preferably variable frequency between 50 Hz and some number of kHz, such as for example 20 kHz. When the induction coil unit 15 with the interior 19 of its induction coil or coil arrangement 21 that is described in greater detail below, is placed substantially centrally on the receiving region 9 of the tool holder 3, this frequency induces eddy currents in the metal body of the tool holder 3 and heats it inductively. The induction current generator 18 may have a conventional design and may, for example, comprise a frequency converter with adjustable power and frequency, fed from a DC intermediate circuit.

For the shrinking process, the tool holder 3 with vertical axis and upwardly-directed receiving opening 11 is located in a receiving or opening of a receptacle 23 on a rotatable 20 turntable 24, which is described in greater detail below and may be rotated about a vertical axis, in axial alignment with the induction coil 21 of the induction coil unit 15, which in turn is guided on a vertical guide column 25 in a manually displaceable manner. Each receptacle 23 forms a holding apparatus for holding a tool holder during a heating process.

A manipulation grip 27 allows one-handed operation and displacement of the induction coil unit 15 as well as the release of a clamp locking apparatus. To further facilitate manipulation, a spring motor 37 is arranged at the upper end of the guide column 25, which drives a rope winding drum, not otherwise shown, with a rope that is guided along the guide column 25 to the induction coil unit 15 in the winding direction. The spring motor 37 at least partially compensates the weight of the induction coil unit 15.

For the heating process, the tool holder is inserted into the receptacle 23 of the turntable 24 and the induction coil unit 15 is lowered from the raised position shown in FIG. 1 until the induction coil 21 surrounds the receiving region 9. By pressing a push button 46 arranged on the induction coil unit 15 in such proximity to the manipulation grip 27 as to be suitable for one-handed operation, the induction current supply of the induction coil 21 is switched on, which is indicated by an indicator lamp 48, likewise arranged on the induction coil unit 15, for the duty cycle of the current. The induction current flows during the actuation period of the button 46; this period may be freely selected. The induction current generator 18 switches off the current only after a predetermined safety period, in order to prevent unintentional heating damage to the tool or tool holder. The operator of the shrink device 1 only actuates the button 46 until the tool 5 sinks into the vertically aligned receiving opening 11 of the tool holder 3, either by itself or with a small amount of manual assistance. Immediately afterward, the induction current may be switched off, thus avoiding unnecessary heating of the tool holder 3.

To avoid the need for removing the tool holder 3 from the receptacle 23 for the subsequent cooling phase, the receptacle 23 is arranged on the turntable 24 and moves together with it, and together with the tool holder 3 seated in the receptacle 23, to a position in which a cooling sleeve 53, which is fed cooling liquid from a cooling unit 51 via flexible hoses 50, is set flat on the receiving region 9 of the tool holder 3. The flat contact of the inner sheath of the cooling sleeve 53 on the outer sheath of the receiving region 9 of the tool holder 3, together with the cooling of the cooling sleeve 53 by the cooling liquid circulating in a closed circuit through the cooling sleeve 53 and the cooling unit 51, ensure very rapid cooling of the tool holder 3 to ambient temperature. In order to prevent burn injuries from the tool holders heated to multiples of 100° C., the turntable 24 is furnished with detents that are effective depending on the direction of rotation and permit rotation only in the direction, indicated by an arrow 55, in which the tool holder 3 on the operator side of the shrink device 1 is moved away from the heating position below the induction coil unit 15 and into the position designated for applying the cooling sleeve 53.

As FIG. 1 shows, the turntable 24 carries more than two, in this case three, receptacles 23 distributed around its circumference, and the cooling unit 51 also feeds a plurality of cooling sleeves 53 simultaneously. In this way, a plurality of tool holders may be cooled simultaneously without impairing the inductive heating of the tool holders. The cooling sleeves 53 have eyelets 55, by which the sleeves are detachably suspended from a supporting wall 57 of the shrink device 1. Slots 59 are also furnished in the supporting wall, into which the cooling liquid hoses 50 of the cooling sleeves 53 are guided in a longitudinally displaceable and orderly manner.

The cooling sleeves 53 may have different inner diameters and different inner shapes depending on the tool holders 3 to be cooled; they may also have the same dimensions 20, if only a single type of tool holder is to be shrunk. The receptacles 23 may also be held detachably on the turntable 24. In the exemplary embodiment shown, the three receptacles 23 are fastened to a common hub 61 with free play, so that the group of these receptacles 23 may be exchanged as a construction unit. The free play of the hub fastening prevents the receptacles 23 from jamming on the centering rings 63 that are furnished for accommodating the receptacles 23 on the turntable 24.

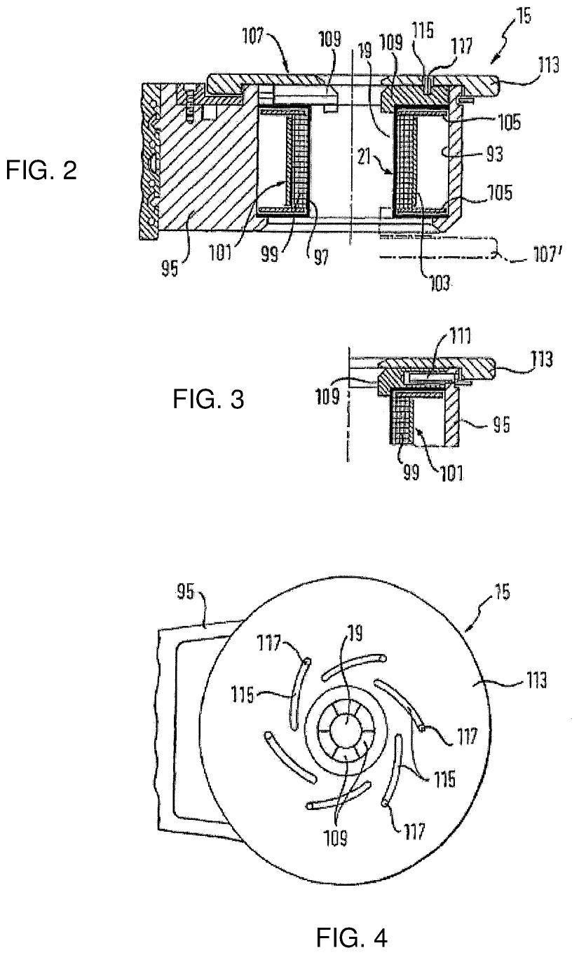

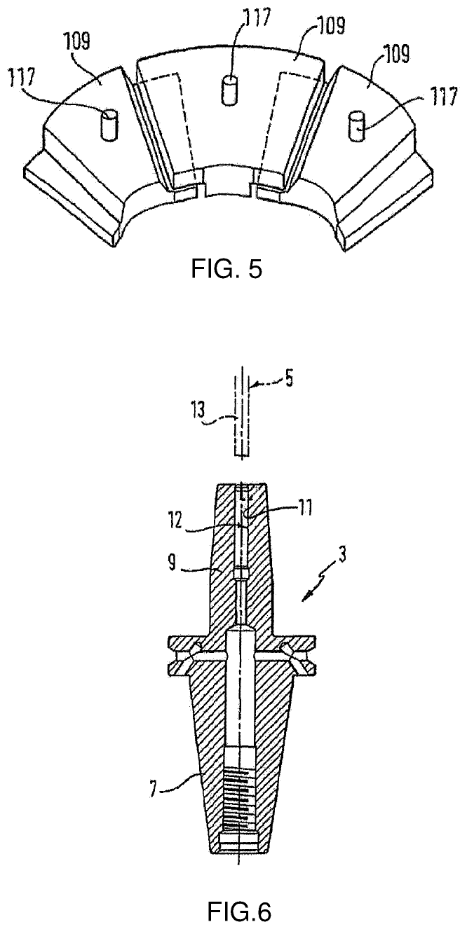

FIGS. 2 to 5 show details of the induction coil unit 15. The induction coil unit 15 carries the wire winding 99 of the induction coil 21 wound on a coil body 97 in a circular cylindrical receiving opening 93 of a base body 95 consisting of non-magnetic material. For the purpose of bundling the magnetic field on the tool holder that will be introduced into the interior of the winding 99 and will be heated inductively, a yoke arrangement 101 of ferromagnetic material, for example ferrite, is arranged on the outside of the winding 99. The yoke arrangement 101 has an axial yoke element 103 that surrounds the outer circumference of the winding 99 in the manner of a sleeve, and may consist of a plurality of plates arranged at a distance from one another, to which are connected yoke elements 105 that engage radially via the axial ends of the winding 99. The yoke elements 105 may be designed as ring discs or also as segment plates arranged at a distance from each other.

The inner diameter of the opening 19 is configured for the maximum diameter of the tool holders that will be heated. In order to obtain sufficiently large induction currents even at a comparatively large radial distance between the winding 99 and the tool holder, at least one axial end of the winding 99 has a pole shoe arrangement or magnetic flux concentrator arrangement 107 with a variable inner diameter that may be selectively adapted to the outer diameter of the tool holder as operating conditions dictate, projecting radially into the opening 19 over the inner circumference of the winding 99. The pole shoe arrangement 107 has a large number of yoke elements 109 of a ferromagnetic material, for example a ferrite material, that are distributed in the circumferential direction of the winding 99 and preferably overlap in the circumferential direction as well, and are respectively guided so as to be radially displaceable on radial pins 111 (FIG. 3) that are fixed firmly to the base body 95. In addition, a control disc 113 is rotatably guided on the base body 95 around the same axis as the induction coil 21; this disc has a control slot 115 for each of the yoke elements 109, which extends obliquely to the circumferential direction and in which a cam follower pin 117 that projects from the yoke element 109 engages. As a result of the control disc 113 rotating, the yoke elements 109 may be moved together radially into the opening 19 or pulled out of the opening. The clear diameter of the pole shoe arrangement 107 may be varied in this way by turning the control disc 113.

In some embodiments, it is sufficient if a pole shoe arrangement 107 of the type described above is arranged on the upper side of the induction coil 21, because in that case, this pole shoe arrangement may then be into overlap with the end face of the tool holder. In 107′, an additional pole shoe arrangement is indicated on the underside of the induction coil 21, which may be furnished alternatively or in addition to the pole shoe arrangement 107. If pole shoe arrangements 107 or 107′ are furnished at the axial ends of the winding 99, the radial yoke elements 105 may also be omitted there.

In addition, the induction coil unit 16 also has a detection device 119, schematically indicated in FIG. 1, for automatically detecting at least one characteristic property of the tool holder 3 that the holding apparatus 23 holds. The detection device 119 in this case is designed to optically determine the at least one property of the tool holder 3 based on its shape and may be designed, for example, as an image detection device, in particular a camera. Alternatively or in addition, a detection device could also be furnished, by means of which the at least one property of the tool holder 3 may be determined based on its weight, its magnetic properties, haptic sensing and/or ultrasound imaging. Alternatively or in addition, a detection device could also be furnished by means of which a coding may be detected that is provided on the tool holder, in particular an optical coding, a label, an RFID chip and/or a mechanical marking.

The induction coil unit 16 also has an actuator device 121, schematically indicated in FIG. 1, for adapting at least one operating parameter of the heating operation. This actuator device 121 is, by way of example, a component of the induction current generator 18 and is set up to adapt parameters of the electrical supply to the coil arrangement 11, in particular the applied AC voltage applied and/or the frequency thereof.

Alternatively or in addition, an actuator device could also be furnished by means of which the positioning of the coil arrangement 11 may be adapted along the axial direction of the tool holder 3 during heating operation. The actuator device could also comprise movable stop means for the coil arrangement 11. In addition, an actuator device could also be furnished, by means of which the positioning of the magnetic flux concentrator arrangement 107 in the radial direction of the tool holder 3 may be adapted in heating operation.

Additionally, the induction coil unit 16 also has a control unit 123, schematically indicated in FIG. 1, that is in data communication respectively with the at least one detection device 119 to obtain data relating to the tool holder 3 and with the at least one actuator device 121 to direct the adaptation of the at least one operating parameter. This control unit 123 is designed to direct an adaptation of the at least one operating parameter based on the detected at least one property of the tool holder 3. This control unit 123 is likewise a component of the induction current generator 18.

A memory unit 125, likewise schematically indicated in FIG. 1, is associated with the control unit 123, and data is stored therein that allows the control unit 123 to determine the type of tool holder 3 that the holding apparatus 23 holds, based on the data received from the detection device 119. Based on the type of tool holder 3 ascertained, the electrical supply to the coil arrangement 11 is then set or adjusted by means of the control unit 123.

1. An induction coil unit for heating a freely-terminating sleeve portion of a tool holder having a receiving opening formed therein for a shank of a rotary tool, in which the freely-terminating sleeve portion holds the shank of the rotary tool seated in the receiving opening in a press fit and releases the rotary tool upon heating, the induction coil unit comprising:
a holding apparatus for holding the tool holder during a heating operation;
a coil configuration enclosing the freely-terminating sleeve portion during the heating operation;
a magnetic flux concentrator configuration disposed on a side of said coil configuration adjacent to a free end of the freely-terminating sleeve portion, said magnetic flux concentrator configuration disposed at least near the free end of the freely-terminating sleeve portion of the tool holder and is made of a weakly-magnetic material that is substantially electrically non-conductive;
at least one detector for automatically detecting at least one property of the tool holder held by said holding apparatus;
at least one actuator for adapting at least one operating parameter of the heating operation; and
a controller being in data communication, respectively, with said at least one detector to obtain data relating to the tool holder, and with said at least one actuator to direct an adaptation of the at least one operating parameter, said controller is adapted to direct the adaptation of the at least one operating parameter based on recognition of at least one property of the tool holder.

2. The induction coil unit according to claim 1, wherein said actuator is adapted to adjust a positioning of said coil configuration during the heating operation.

3. The induction coil unit according to claim 2, wherein said actuator has a movable stop means for said coil configuration.

4. The induction coil unit according to claim 1, wherein said actuator is adapted to adjust a positioning of said magnetic flux concentrator configuration in a tool holder's axial and/or radial direction during the heating operation.

5. The induction coil unit according to claim 1, further comprising:
at least one suction device for vapor produced during heating; and/or
a sealing element for cooling media, said actuator is adapted to adjust a positioning of said at least one suction device and/or said at least one sealing element for cooling media in a tool holder's axial and/or radial direction during the heating operation.

6. The induction coil unit according to claim 1, wherein:
said coil configuration has an adjustable geometry and/or switchable and/or reversible-polarity winding region; and
said actuator is adapted to adjust a geometry of said coil configuration.

7. The induction coil unit according to claim 1, wherein said actuator is adapted to adjust parameters of an electrical supply to said coil configuration.

8. The induction coil unit according to claim 1, wherein said detector is adapted to optically determine the at least one property of the tool holder held by said holding apparatus based on its shape, its weight, its magnetic properties, haptic sensing and/or ultrasonic imaging.

9. The induction coil unit according to claim 1, wherein said detector is adapted to detect a coding furnished on the tool holder.

10. The induction coil unit according to claim 1, further comprising a memory connected to said controller and in said memory data are stored that enable said controller to determine a type of tool holder is held by said holding apparatus, based on information obtained from said detector.

11. The induction coil unit according to claim 1, wherein said actuator is adapted to adjust a positioning of said coil configuration along an axial direction of the tool holder during the heating operation.

12. The induction coil unit according to claim 7, wherein said actuator is adapted to adjust an AC voltage and/or a frequency of the AC voltage.

13. The induction coil unit according to claim 9, wherein the coding is selected from the group consisting of an optical coding, an inscription, a radio frequency identification chip and a mechanical marking.

14. The induction coil unit according to claim 6, wherein said actuator is adapted to adjust a diameter and/or an axial distance between said winding regions and/or to switch said winding regions of said coil configuration on or off and/or to reverse a polarity of the winding regions.
